(19) United States
(12) Patent Application Publication
(10) Pub. No.: US 2026/0152972 A1
(43) Pub. Date: Jun. 4, 2026

(54) BUTTON-TYPE COMBINATION LOCK

(71) Applicant: ABA LOCKS INTERNATIONAL CO., LTD., New Taipei City (TW)

(72) Inventor: Miko LEE, New Taipei City (TW)

(21) Appl. No.: 19/000,881

(22) Filed: Dec. 24, 2024

(30) Foreign Application Priority Data
Dec. 4, 2024 (TW) 113147044

(51) Int. Cl. E05B 37/00

(52) U.S. Cl. CPC E05B 37/0048

(57) ABSTRACT

A button-type combination lock which has a reset state comprises a housing, a lock core assembly, a password pad assembly, a latch, and a reset device. The lock core assembly includes a core casing and a lock core. The password pad assembly includes multiple button sets, an unlocking driving piece, a fixing driving piece, and a resetting driving piece. Each one of the button sets has a main body and a guiding sleeve, and the guiding sleeve is sleeved on the main body. The button sets are mounted through the fixing driving piece. The resetting driving piece is sleeved on the button sets. When the button-type combination lock is under the reset state, the reset device is connected to the lock core, the lock core is in a resetting position, and the resetting driving piece presses the guiding sleeves, thereby placing the guiding sleeves in a first position. The button-type combination lock allows the user to reset password by the reset device and the lock core combined with the password pad assembly.

### BACKGROUND

### 1. Field of the Invention

The present invention relates to a button-type combination lock, especially to a button-type combination lock that facilitates password changing at a front side and ease in resetting the password via a reset device.

### 2. Description of the Prior Arts

A combination lock, as known as a password lock, is a common lock which has mechanisms cooperating with each other for the user to input a correct password to unlock. Combination locks may be divided into two types depending on being password-changeable or not. Since those password-unchangeable combination locks would be hardly useful any more if the password is cracked or forgotten, the user usually prefers to use the combination locks which are password-changeable.

However, even the combination locks that are password-changeable still have inconvenience in use. For example, the user must have the correct password before they can change the password. Therefore, if the user has forgotten the original password, the user needs to take huge effort to crack the original password before changing the password. In order to deal with this condition, some of the combination locks are designed to allow the user to reset the password back to a default password, but in order to avoid the aforementioned function from being a shortcut for malicious people to crack the locks, the mechanisms/interfaces for resetting passwords are usually hidden according to the characteristics of the lock. For example, the combination lock for a cabinet may hide the reset mechanism/interface inside the cabinet or between the cabinet and itself, thereby making it impossible for those malicious people to easily crack the lock via the reset mechanism.

However, the aforementioned design also causes trouble to the user. When changing the password, the user has to open the door of the cabinet and then changes the password at the back side of the door, which brings great inconvenience. The user would be unable to open the door of the cabinet once the password is forgotten, and then the user needs to destroy the door, and buys a new door and a new lock to continue using the cabinet.

To overcome the shortcomings, the present invention provides a button-type combination lock to mitigate or obviate the aforementioned problems.

### SUMMARY

The main objective of the present invention is to provide a button-type combination lock that facilitates not only changing password at a front side but also resetting password via a reset device.

The button-type combination lock, which has a reset state, comprises a housing, a lock core assembly, a password pad assembly, and a latch. The housing has a first direction and a second direction which are nonparallel to each other, and a surface of the housing oriented in the first direction is an operating surface. The housing has an accommodating chamber formed in the housing and a core recess recessed from the operating surface of the housing, and the core recess and the accommodating chamber spatially communicating with each other. The lock core assembly is mounted in the core recess and has a core casing mounted in the core recess and protruding from the operating surface, and a lock core mounted in the core casing and rotatable to a reset position with respect to the core casing. The password pad assembly is mounted in the accommodating chamber and has multiple button sets, an unlocking driving piece, a fixing driving piece, and a resetting driving piece. The button sets are mounted in the accommodating chamber, and each one of the button sets includes a main body disposed through and protruding from the operating surface, and the main body movable along the first direction, and a guiding sleeve sleeved on the main body and movable with respect to the main body along the first direction, and the guiding sleeve selectively located at a first position or a second position with respect to the main body. The unlocking driving piece is connected to the core casing, and the button sets mounted through the unlocking driving piece. The unlocking driving piece is movable along the second direction, thereby engaging with the guiding sleeves. The button sets are mounted through the fixing driving piece; the fixing driving piece is movable along the second direction, thereby engaging with the main bodies. The resetting driving piece is sleeved on the button sets and movable along the second direction, thereby one or more of the guiding sleeves located at the second position being pushed to the first position. The latch is mounted through the housing and connected to the core casing. When the button-type combination lock is under the reset state, the lock core is at the reset position, the fixing driving piece engages with the main bodies, the resetting driving piece pushes the guiding sleeves, and thereby each one of the guiding sleeves is located at the first position.

Hence, the button-type combination lock in this disclosure would be under the reset state via the reset device connecting with the lock core. Thus, when the user is going to reset the password, the button-type combination lock in this disclosure does not need to be fully disassembled or be detached from the locked objects such as cabinets or drawers, or the locked objects do not need to be disassembled or destroyed, for changing the password. The user may easily reset the password. In addition, due to the password being resettable, the user does not need to worry about forgetting the password.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a button-type combination lock in accordance with the present invention shown under a locked state, and the reset device is omitted;

FIG. 2 is an exploded view of the button-type combination lock in FIG. 1;

FIG. 3 is a front view of the button-type combination lock in FIG. 1, shown under the locked state;

FIG. 4 is a side view of the button-type combination lock in FIG. 1, shown under the locked state;

FIG. 5 is an exploded view of the lock core assembly in FIG. 2;

FIG. 6 is a cross-sectional view of the button-type combination lock taken across line 6-6 in FIG. 3;

FIG. 7 is a cross-sectional view of the button-type combination lock taken across line 7-7 in FIG. 4;

FIG. 8 is a cross-sectional view of the button-type combination lock taken across line 8-8 in FIG. 4;

FIG. 9 is an exploded view of the password pad assembly in FIG. 2;

FIG. 10 is a cross-sectional view of the button-type combination lock taken across line 10-10 in FIG. 4;

FIG. 11 is a cross-sectional view of the button-type combination lock taken across line 11-11 in FIG. 3;

FIG. 12 is a partial enlarged perspective view which shows the password pad assembly connected to the core casing of the button-type combination lock in FIG. 1 when under the unlocked state;

FIG. 13 is a front view of the button-type combination lock in FIG. 1, shown under the unlocked state;

FIG. 14 is a cross-sectional view of the button-type combination lock taken across line 14-14 in FIG. 13;

FIG. 15 is a partial back view of the password pad assembly of the button-type combination lock in FIG. 13, showing the relative positions of the fixing driving piece and the button sets;

FIG. 16 is another front view of the button-type combination lock in FIG. 1, in which a wrong password is input;

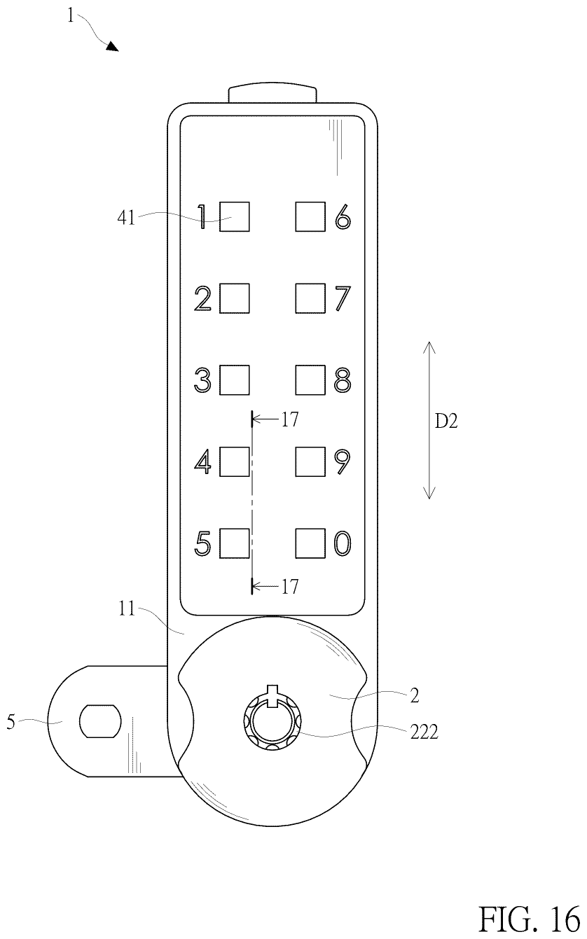

FIG. 17 is a cross-sectional view of the button-type combination lock taken across line 17-17 in FIG. 16;

FIG. 18 is a perspective view of the button-type combination lock in FIG. 1, shown under the reset state and the pushing portion pressed;

FIG. 19 is a top view of the button-type combination lock in FIG. 18;

FIG. 20 is a cross-sectional view of the button-type combination lock taken across line 20-20 in FIG. 19;

FIG. 21 is a cross-sectional view of the button-type combination lock taken across line 21-21 in FIG. 19; and

FIG. 22 is a partial cross-sectional view of the button-type combination lock taken across line 22-22 in FIG. 19, the housing is omitted, and the handle portion and the annular wall portion are shown transparent.

### DETAILED DESCRIPTION

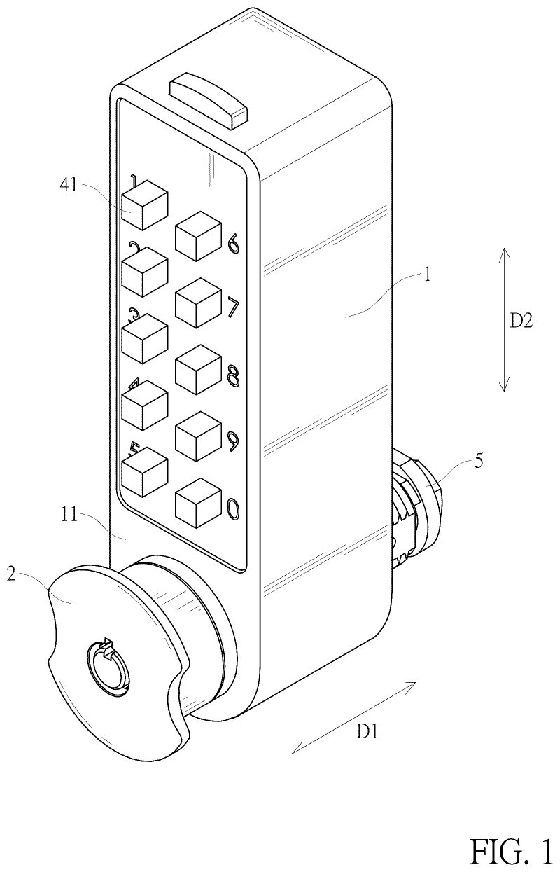

With reference to FIGS. 1, 13, and 18, a button-type combination lock in accordance with the present invention has a locked state, an unlocked state, and a reset state, and the button-type combination lock comprises a housing 1, a lock core assembly 2, a password pad assembly 4, a latch 5 and a reset device 6.

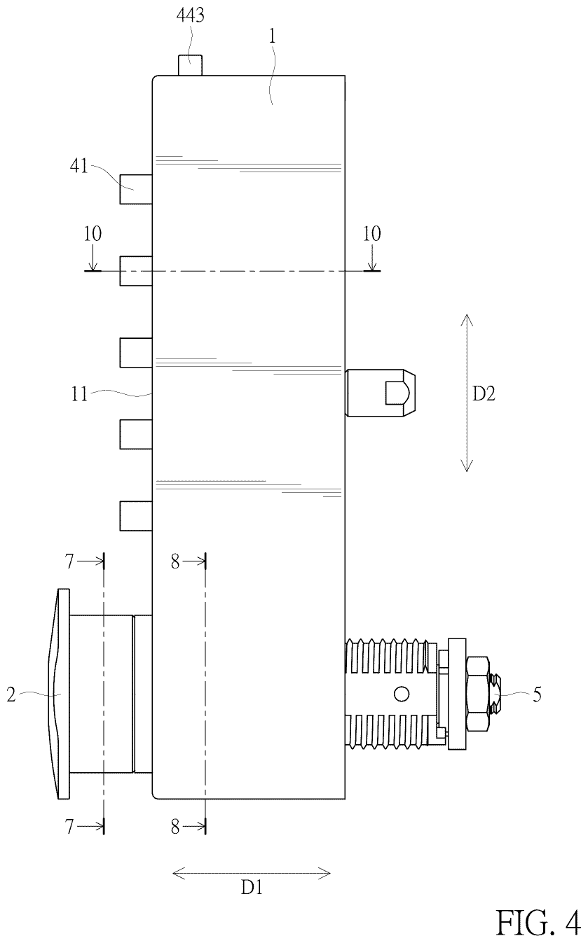

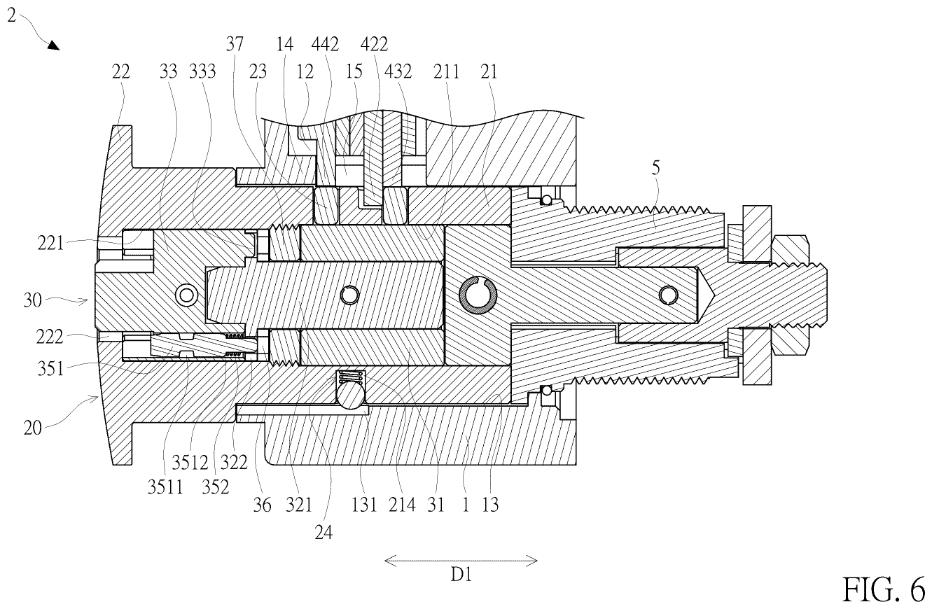

With reference to FIGS. 1 to 4, the housing 1 has a first direction D1 and a second direction D2 which are nonparallel to each other. An external surface of the housing 1 which is oriented in the first direction D1 is an operating surface 11. The housing 1 has an accommodating chamber 12 and a core recess 13. The accommodating chamber 12 is formed in the housing 1, and the core recess 13 is recessed from the operating surface 11 of the housing 1. The accommodating chamber 12 and the core recess 13 are disposed along the second direction D2 and spatially communicating with each other. To be more precise, the accommodating chamber 12 and the core recess 13 are located at two opposite ends of the housing 1 along the second direction D2, and a partition 14 is located between the accommodating chamber 12 and the core recess 13. The partition 14 forms a communicating gap 15 along the first direction D1, and thereby the accommodating chamber 12 and the core recess 13 spatially communicate with each other. With reference to FIG. 6 together, in this embodiment, the core recess 13 is a cylindrical space, and a positioning groove 131 is recessed from an inner annular surface of the core recess 13. The positioning groove 131 extends along the first direction D1, but it is not limited thereto.

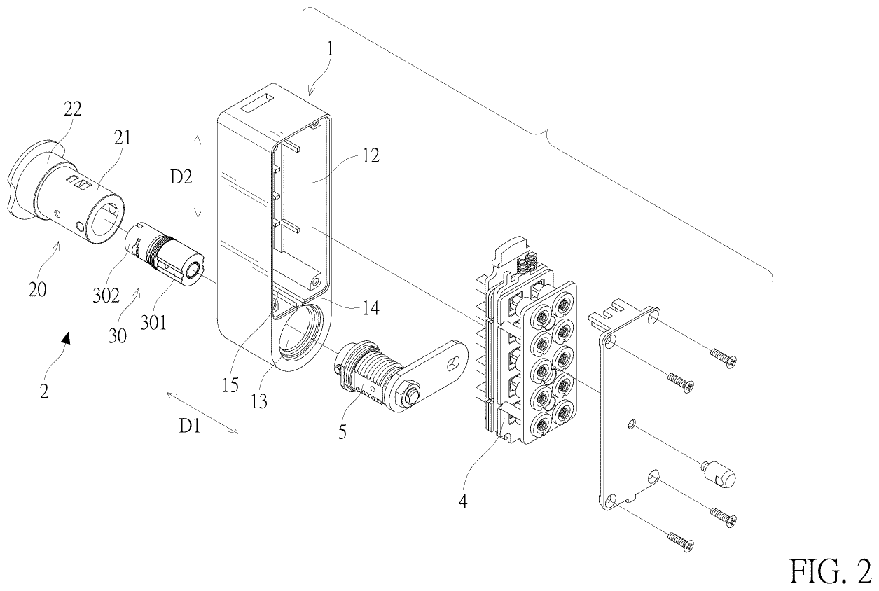

With reference to FIGS. 2 to 5, the lock core assembly 2 is mounted in the core recess 13 and protrudes from the operating surface 11. In this embodiment, the lock core assembly 2 includes a core casing 20 and a lock core 30. The core casing 20 is mounted in the core recess 13 and protrudes from the operating surface 11. The core casing 20 in this embodiment has an annular wall portion 21, a handle portion 22, two spacing blocks 23 and a positioning device 24.

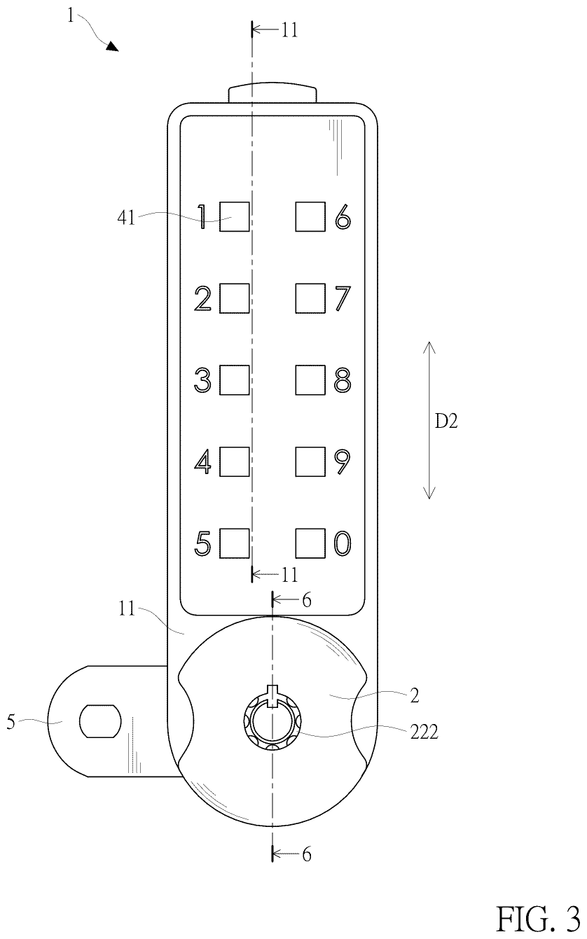

With reference to FIGS. 3 to 8, the annular wall portion 21 is cylindrical in shape, surrounding and forming an inner mounting recess 211. The annular wall portion 21 is disposed in the core recess 13 and is rotatable with respect to the housing 1. The annular wall portion 21 has two lateral holes 212, a side recess 213, and a lateral mounting recess 214. The two lateral holes 212 are formed through the annular wall portion 21 along a radial direction of the annular wall portion 21, and the two lateral holes 212 spatially communicate with the inner mounting recess 211.

The side recess 213 is recessed from an outer annular surface of the annular wall portion 21, and in this embodiment, the side recess 213 has two inclined bottom surfaces, thereby the side recess 213 being wedge in shape. To be more precise, said two bottom surfaces of the side recess 213 are connected to each other by an end, and another end of each one of the two bottom surfaces is connected the outer annular surface of the annular wall portion 21, and thereby the two bottom surfaces are inclined from the outer annular surface toward an interior of the annular wall portion 21. In this embodiment, the two lateral holes 212 and the side recess 213 are arranged along the first direction D1, and thus, when the button-type combination lock in this disclosure is under the locked state, the openings of the two lateral holes 212 and the side recess 213 all face towards the communicating gap 15. Besides, in this embodiment, the side recess 213 is located between the two lateral holes 212, and the side recess 213 spatially communicates with one of the lateral holes 212.

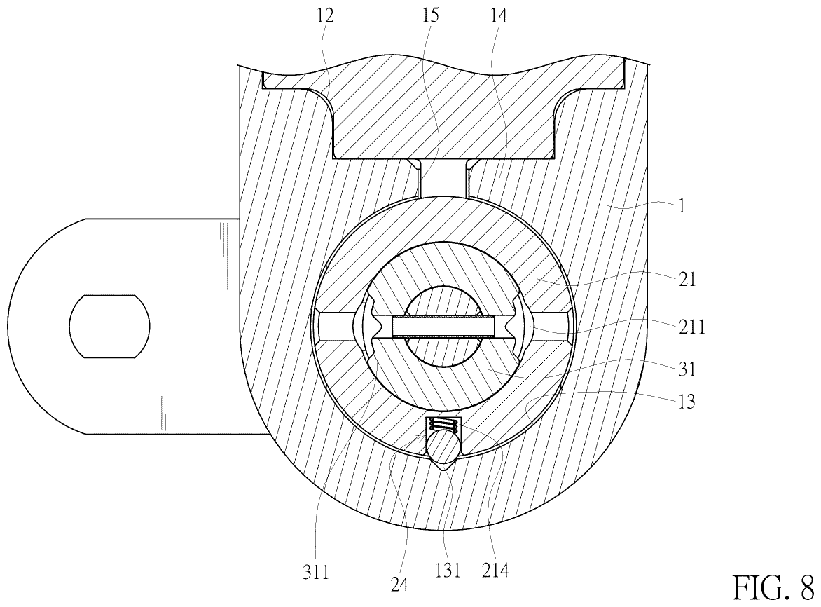

With reference to FIGS. 6 and 8, the lateral mounting recess 214 is recessed from the outer annular surface of the annular wall portion 21 along the radial direction of the annular wall portion 21, and when the button-type combination lock is under the locked state, an opening of the lateral mounting recess 214 faces towards the positioning groove 131 which is on the inner annular surface of the core recess 13.

With reference to FIGS. 3 to 8, an end of the handle portion 22 is fixed on and connected to the annular wall portion 21, and another end of the handle portion 22 protrudes from the operating surface 11. The user may rotate the handle portion 22, and thereby further rotate the annular wall portion 21 with respect to the core recess 13. The handle portion 22 has an outer mounting recess 221 which is formed through the handle portion 22 along the first direction D1. The outer mounting recess 221 and the inner mounting recess 211 spatially communicate with each other, and the outer mounting recess 221 forms a keyhole 222 at the end of handle portion 22 which is away from the annular wall portion 21. In this embodiment, the handle portion 22 and the annular wall portion 21 are integrally formed together, but it is not limited thereto.

The two spacing blocks 23 are movably mounted in the two lateral holes 212 respectively; to be more precise, the two spacing blocks 23 are movable along the radial direction of the annular wall portion 21 in the lateral holes 212, and move inwardly into the inner mounting recess 211. In this embodiment, two opposite ends of each one of the two spacing blocks 23 along the radial direction of the annular wall portion 21 are an inner end portion 231 and an outer end portion 232, respectively. The inner end portion 231 is shaped like a sharp tip and abuts on an outer annular surface of the lock core 30 while the outer end portion 232 is planar shaped. When the inner end portion 231 abuts the outer annular surface of the lock core 30, an end surface of the outer end portion 232 is level with the outer annular surface of the annular wall portion 21.

The positioning device 24 is mounted in the lateral mounting recess 214, and in this embodiment, the positioning device 24 comprises a compression spring 241 and a ball 242. An end of the compression spring 241 is connected to a bottom surface of the lateral mounting recess 214, and another end of the compression spring 241 is connected to the ball 242, thereby the compression spring 241 pushing the ball 242 outwardly along the radial direction of the annular wall portion 21 with the elasticity stored by the compression spring 241. When the button-type combination lock is under the locked state, the opening of the lateral mounting recess 214 faces towards the positioning groove 131 formed on the inner annular surface of the core recess 13, and thus the ball 242 is pressed into the positioning groove 131 by the compression spring 241; when the annular wall portion 21 is rotating with respect to the core recess 13, the ball 242 would be pressed into the lateral mounting recess 214. With the positioning device 24 and the positioning groove 131, a rotating angle of the core casing 20 may be defined in range, but it is not limited thereto, there may not have the positioning device 24 and the positioning groove 131 in another embodiment.

With reference to FIGS. 2 and 5 to 8, the lock core 30 is mounted in the core casing 20 and is rotatable to a reset position with respect to the core casing 20. The lock core 30 has a driven set 301 and a combining set 302. The driven set 301 is mounted in the inner mounting recess 211 and has an inner rotating cylinder 31 and an axle 32.

The inner rotating cylinder 31 is located in the inner mounting recess 211 and rotatable with respect to the inner mounting recess 211, and the inner end portions 231 of the two spacing blocks 23 abut an outer annular surface of the inner rotating cylinder 31. A linear groove 311 is recessed from the outer annular surface of the inner rotating cylinder 31 and extends along an axial direction of the inner rotating cylinder 31. When the lock core 30 is at the reset position, the linear groove 311 spatially communicates with the two lateral holes 212, and the two spacing blocks 23 are in the linear groove 311. To be more precise, when the lock core 30 is at the reset position, the inner rotating cylinder 31 rotates with respect to the annular wall portion 21 until the linear groove 311 is aligned with the two lateral holes 212, and thus the two spacing blocks 23 are pressed into the linear groove 311 by the password pad assembly 4. In this embodiment, a configuration of the linear groove 311 is similar to the side recess 213 of the annular wall portion 21. The linear groove 311 may have two inclined bottom surfaces which are connected to each other, and thereby when the inner rotating cylinder 31 is rotating, the inner end portions 231 of the two spacing blocks 23 would slide out along the bottom surfaces of the linear groove 311 to the outer annular surface of the inner rotating cylinder 31, but it is not limited thereto.

The axle 32 is fixed and mounted through the inner rotating cylinder 31 and extends to the outer mounting recess 221. In this embodiment, The axle 32 includes a shank portion 321 and a disc portion 322. The shank portion 321 is disposed through the inner rotating cylinder 31, and an end of the shank portion 321 protrudes from the inner rotating cylinder 31 and towards the handle portion 22. The disc portion 322 is connected to an outer annular surface of the shank portion 321 and surrounds the shank portion 321, and the disc portion 322 is disposed at the end of the shank portion 321 oriented to the handle portion 22. Multiple connecting holes 3221 are formed through the disc portion 322, and the connecting holes 3221 are arranged spaced apart from each other and along a rim of the disc portion 322.

With reference to FIGS. 2, 5, and 6, the combining set 302 is mounted in the outer mounting recess 221 and connected to the axle 32 of the driven set 301. In this embodiment, the combining set 302 has an outer rotating cylinder 33, a linking unit 34, multiple lock pin modules 35, an anti-cracking unit 36, and a compressing unit 37.

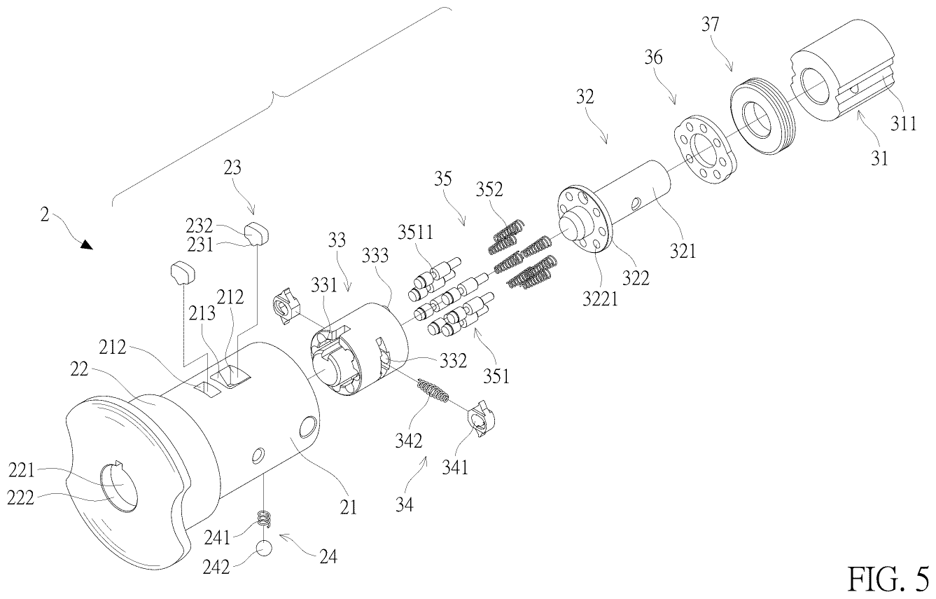

With reference to FIGS. 5 to 8, the outer rotating cylinder 33 is disposed in the outer mounting recess 221 and is rotatable with respect to the handle portion 22, and the outer rotating cylinder 33 is connected to the axle 32. The outer rotating cylinder 33 has multiple pin channels 331 and a lateral crossing channel 332, the pin channels 331 are formed through the outer rotating cylinder 33 along an axial direction of the outer rotating cylinder 33, and the pin channels 331 are spaced apart from each other along a circumferential direction of the outer rotating cylinder 33. The lateral crossing channel 332 is formed through the outer rotating cylinder 33 along a radial direction of the outer rotating cylinder 33, and the lateral crossing channel 332 spatially communicates with at least one of the pin channels 331. In this embodiment, two opposite ends of the lateral crossing channel 332 spatially communicate with three pin channels 331, but it is not limited thereto.

In addition, in this embodiment, an end surface of the outer rotating cylinder 33 contacts the disc portion 322 of the axle 32, and the pin channels 331 are respectively aligned with the connecting holes 3221. The end surface of the outer rotating cylinder 33 which contacts the disc portion 322 has a protrusion 333, which is disposed in one of the connecting holes 3221 of the disc portion 322, such that the outer rotating cylinder 33 is capable of driving the axle 32 to rotate, but it is not limited thereto.

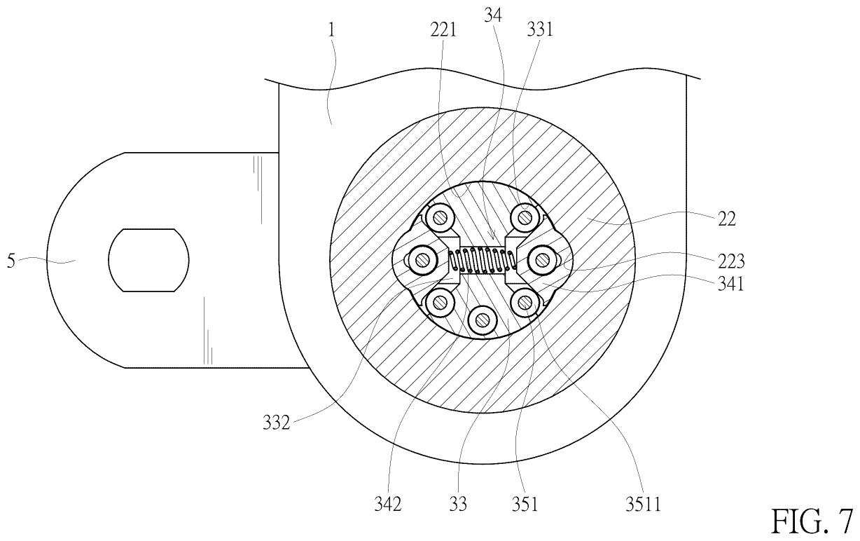

As shown in FIG. 7, the linking unit 34 is movably mounted in the lateral crossing channel 332, and the linking unit 34 selectively protrudes from the outer annular surface of the outer rotating cylinder 33, thereby the linking unit 34 engaging into a driven recess 223 formed on an inner annular surface of the outer mounting recess 221. To be more precise, two driven recesses 223 are recessed from the inner annular surface of the outer mounting recess 221, and the two driven recesses 223 are located at two opposite sides of a radial direction of the outer mounting recess 221. The two driven recesses 223 are capable of being aligned with two openings at two ends of the lateral crossing channel 332. The linking unit 34 has two engaging pieces 341 and a compression spring 342, and the two engaging pieces 341 are located at the two openings at the two ends of the lateral crossing channel 332 respectively, and two ends of the compression spring 342 are connected to the two engaging pieces 341 respectively, and thus the compression spring 342 would have a tendency of pressing the two engaging pieces 341 outwardly from the outer rotating cylinder 33 with the elasticity stored by the compression spring 342. Once the two driven recesses 223 are aligned with the two openings at the ends of the lateral crossing channel 332, the compression spring 342 would push the two engaging pieces 341 to protrude from the outer annular surface of the outer rotating cylinder 33, such that the two engaging pieces 341 engage into the two driven recesses 223.

With reference to FIGS. 5 to 7, the lock pin modules 35 are mounted through the pin channels 331, and each one of the lock pin modules 35 comprises a lock pin 351 and a restoring spring 352. The lock pin 351 is disposed in the pin channel 331 and is movable with respect to the outer rotating cylinder 33 along the axial direction of the outer rotating cylinder 33. Specifically, the lock pin 351 may be moved along the pin channel 331 and penetrate into the connecting hole 3221 of the disc portion 322 of the axle 32. In this embodiment, the two engaging pieces 341 are penetrated by two of the six lock pins 351 which are disposed in the six pin channels 331 spatially communicating with the lateral crossing channel 332, said two lock pins 351 are capable of moving with respect to the engaging pieces 341, but it is not limited thereto. The lock pin 351 has a receiving recess 3511 which is recessed from an outer annular surface of the lock pin 351. Furthermore, lengths of the lock pins 351 of the lock pin modules 35 may be different from each other, or locations of the receiving recesses 3511 along length directions of the lock pins 351 may be different from each other. When the lock core 30 is at the reset position, the receiving recesses 3511 are aligned with the lateral crossing channel 332, thereby the linking units 34 engaging into the receiving recesses 3511.

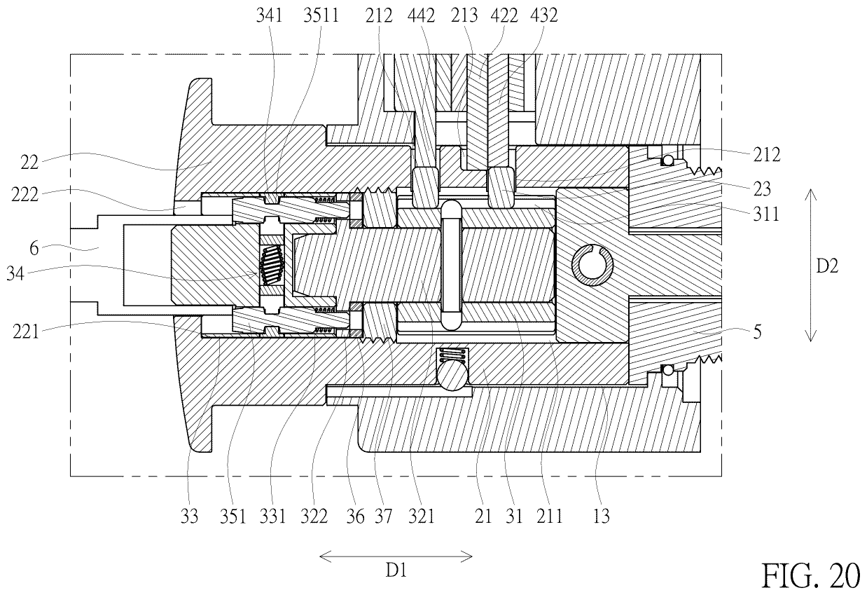

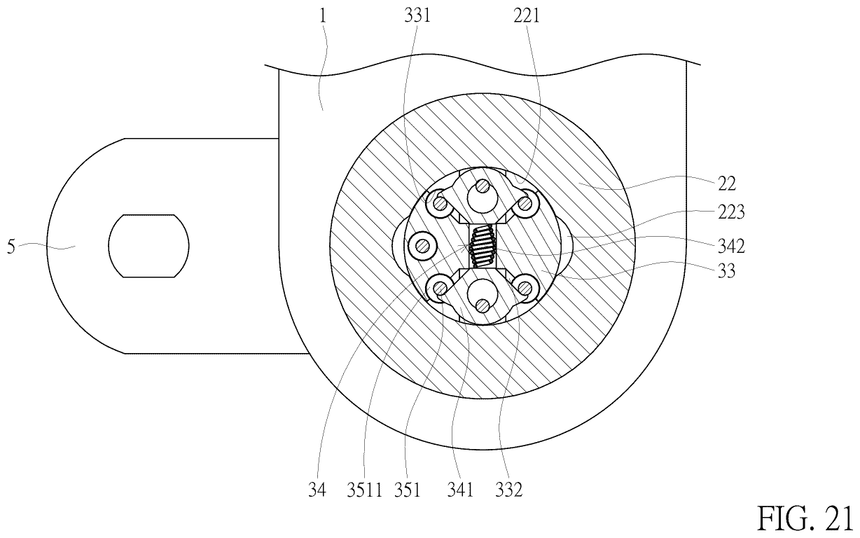

With reference to FIGS. 20 and 21, when the receiving recesses 3511 of the lock pins 351 are aligned with the lateral crossing channel 332 along the first direction D1 of the housing 1, the engaging pieces 341 of the linking unit 34 may enter the receiving recesses 3511. To be more precise, with reference to FIG. 6 7, in this embodiment, when the receiving recesses 3511 are not aligned with the lateral crossing channel 332, the engaging pieces 341 of the linking unit 34 would be limited by the lock pins 351 which are disposed in the six pin channels 331 spatially communicating with the lateral crossing channel 332, and would protrude from the outer annular surface of the outer rotating cylinder 33 and engage into the two driven recesses 223; meanwhile, if the outer rotating cylinder 33 is rotated, the engaging pieces 341 would drive the handle portion 22 to rotate together. Instead, with reference to FIGS. 20 and 21, if the lateral crossing channel 332 is aligned with the receiving recesses 3511 of the lock pins 351 which are disposed in the six pin channels 331 spatially communicating with the lateral crossing channel 332, then the receiving recesses 3511 provide a space for the engaging pieces 341 to move inwardly, and thus the outer rotating cylinder 33 is rotatable with respect to the handle portion 22 without driving the handle portion 22 to rotate together, and thereby the lock core 30 is rotated with respect to the core casing 20 to the reset position. To be more precise, when the receiving recesses 3511 provides the space for the engaging pieces 341 to move inwardly, the engaging piece 341 would move out from the driven recesses 223 and be pressed by the inner annular surface of the handle portion 22 during rotation of the outer rotating cylinder 33, and furthermore, the compression spring 342 and the engaging pieces 341 move inwardly along the radial direction of the outer rotating cylinder 33.

The restoring spring 352 is sleeved on the lock pin 351. To be more precise, each one of the lock pins 351 has an abutting surface 3512 which faces towards the disc portion 322. An end of the restoring spring 352 abuts the abutting surface 3512 of the lock pin 351, and another end of the restoring spring 352 abuts the disc portion 322, and thus the restoring spring 352 is capable of pushing the lock pin 351 away from the disc portion 322 with the elasticity it stores, and resetting the lock pin 351.

With reference to FIGS. 5 and 6, the anti-cracking unit 36 is mounted at an end of the outer rotating cylinder 33 and engages with the core casing 20. Multiple holes are formed through the anti-cracking unit 36, and the holes are aligned with the pin channels 331. The anti-cracking unit 36 in this embodiment is sleeved on the shank portion 321 of the axle 32 and abuts the disc portion 322, thereby the lock pins 351 being capable of passing through the disc portion 322 and entering the holes of the anti-cracking unit 36. The anti-cracking unit 36 engages into the inner annular surface of the outer mounting recess 221, so the anti-cracking unit 36 would drive the handle portion 22 to rotate together. If any one of the lock pins 351 passes through the disc portion 322 and enters the anti-cracking unit 36, then the handle portion 22 would be driven to rotate by the outer rotating cylinder 33. Hence, the lock core 30 cannot be rotated to the reset position with respect to the core casing 20. A configuration of the anti-cracking unit 36 is not limited thereto, for example, the anti-cracking unit 36 may be integrally formed with the handle portion 22.

In this embodiment, the combining set 302 may further have a compressing unit 37 mounted in the outer mounting recess 221. The compressing unit 37 is ring-shaped and forms multiple annular ribs on an outer annular surface. The compressing unit 37 is sleeved on the shank portion 321 of the axle 32, and the compressing unit 37 is engaged between the inner mounting recess 211 and the outer mounting recess 221 by the annular ribs on the outer annular surface. Therefore, the compressing unit 37, the anti-cracking unit 36, the disc portion 322 of the axle 32, and the outer rotating cylinder 33 abut one another tightly to prevent a gap appearing between the anti-cracking unit 36 and the disc portion 322, which would lead to the anti-cracking unit 36 losing function.

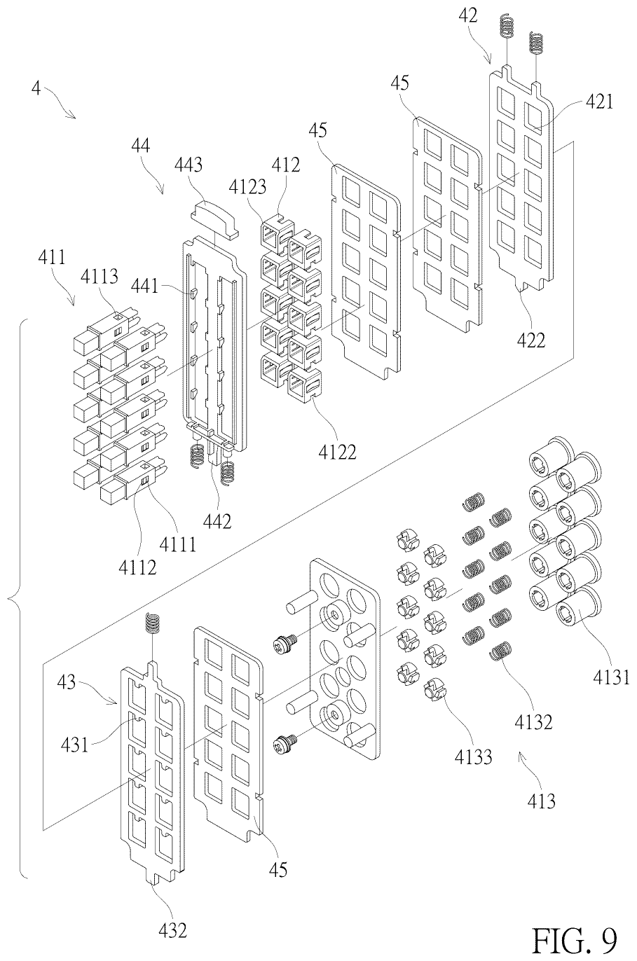

With reference to FIGS. 2 to 4, 6, and 9, the password pad assembly 4 is mounted in the accommodating chamber 12 and connected to the lock core assembly 2. The password pad assembly 4 comprises multiple button sets 41, an unlocking driving piece 42, a fixing driving piece 43, a resetting driving piece 44, and multiple spacing pieces 45.

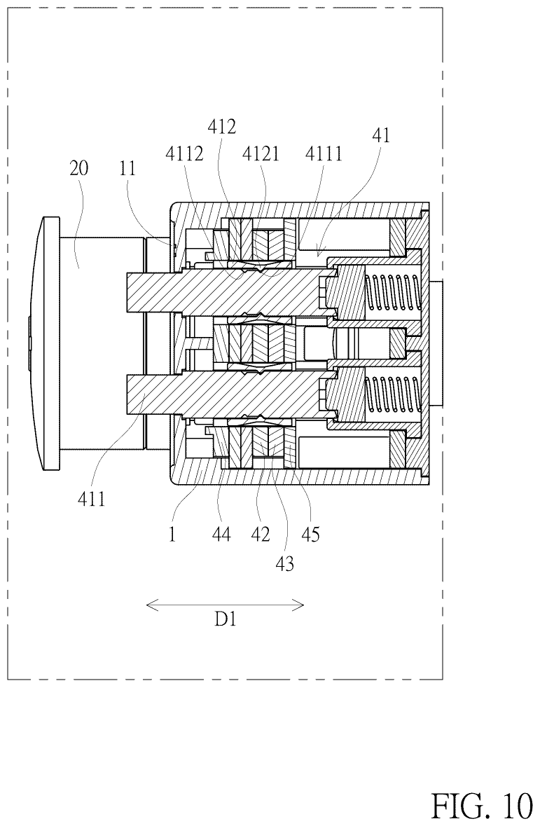

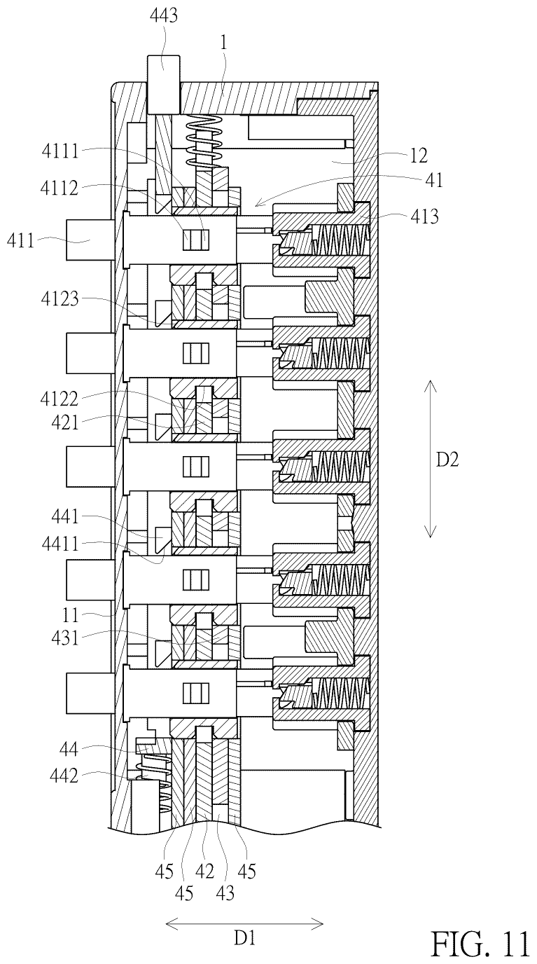

With reference to FIGS. 2 to 4, 6, and 9 to 11, the button sets 41 are mounted in the accommodating chamber 12. There are ten button sets 41 in this embodiment representing number 0 to number 9, but a quantity of the button sets 41 is not limited thereto. Each one of the button sets 41 comprises a main body 411, a guiding sleeve 412, and a pressing set 413.

The main bodies 411 are disposed through and protrude from the operating surface 11, and the main bodies 411 are movable along the first direction D1 of the housing 1. In this embodiment, each one of the main bodies 411 is shaped as a rectangular rod and has a first limit recess 4111, a second limit recess 4112, and a fixing combining recess 4113. The first limit recess 4111 and the second limit recess 4112 are recessed from an external lateral surface of the main body 411 and arranged spaced apart from each other along the first direction D1 of the housing 1. The fixing combining recess 4113 is recessed from a surface of the main body 411 and said surface faces away from the lock core assembly 2. In this embodiment, the second limit recess 4112 is located between the operating surface 11 and the first limit recess 4111 in the first direction D1.

The guiding sleeves 412 are sleeved on the main bodies 411 and are movable with respect to the main bodies 411 along the first direction D1. Each one of the guiding sleeves 412 is selectively located at a first position or a second position with respect to the main body 411. To be more precise, each one of the guiding sleeves 412 has a positioning rib 4121 protruding from an internal surface of the guiding sleeve 412. The positioning rib 4121 selectively engages with one of the first limit recess 4111 and the second limit recess 4112. When the guiding sleeve 412 is at the first position, the positioning rib 4121 is engaged with the first limit recess 4111, and when the guiding sleeve 412 is at the second position, the positioning rib 4121 is engaged with the second limit recess 4112. In this embodiment, the guiding sleeve 412 is also shaped as a rectangular sleeve to meet the shape of the main body 411.The guiding sleeve 412 has an unlocking combining recess 4122 which is recessed from a surface of the guiding sleeve 412, and said surface faces towards the lock core assembly 2. Furthermore, an inclined surface 4123 is connected between a surface facing away from the lock core assembly 2 and an end surface of the guiding sleeve 412 which faces towards the operating surface 11 to form a chamfer structure, but it is not limited thereto.

The pressing sets 413 are fixed and mounted in the accommodating chamber 12 and connected to the main bodies 411; to be more precise, the pressing sets 413 are fixed and connected to a side of the housing 1 away from the operating surface 11. Each one of the pressing sets 413 is capable of abutting a corresponding one of the main bodies 411, and thereby the main body 411 is selectively at an elevated position or a pushed position along the first direction D1 with respect to the accommodating chamber 12.

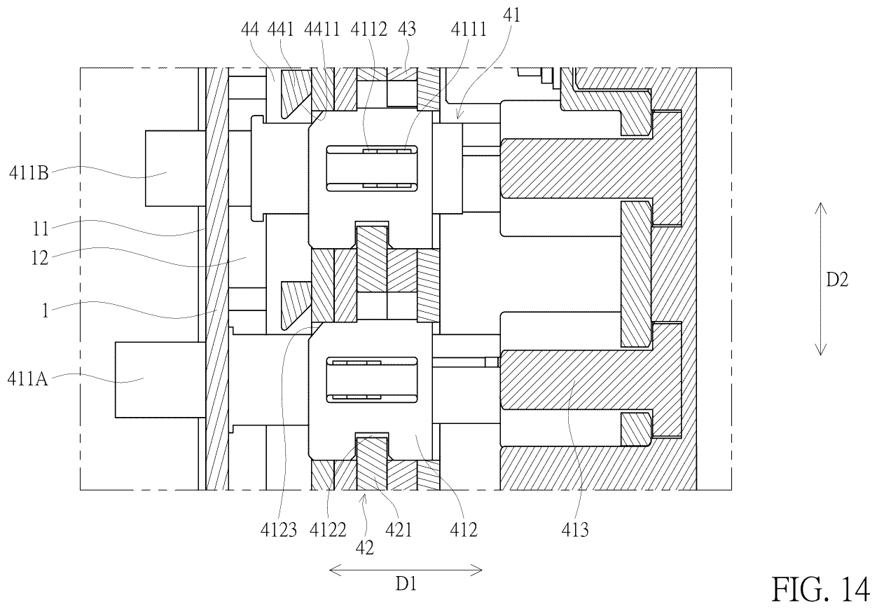

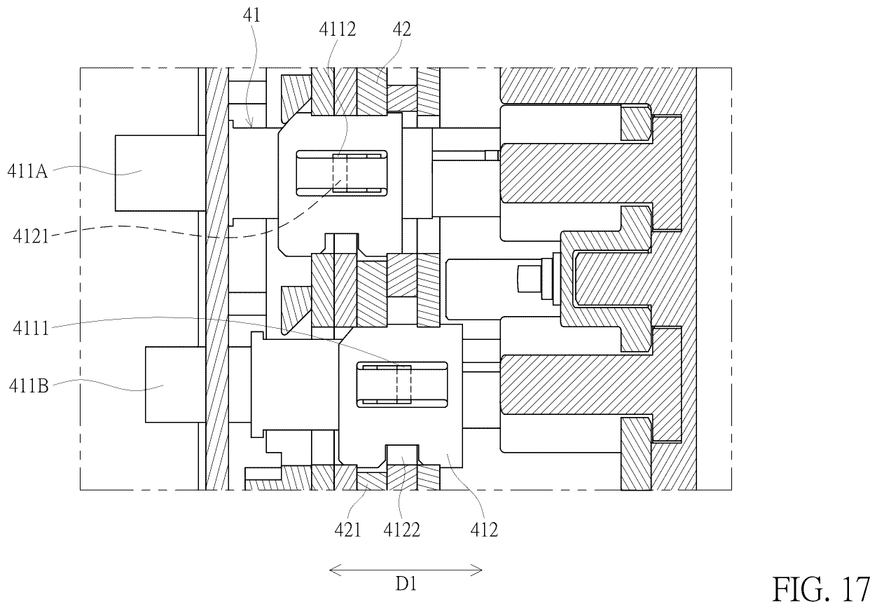

To be more precise, each one of the pressing sets 413 comprises an external cylinder 4131, a spring 4132, and a displacement unit 4133. The external cylinder 4131 has ribs protruded from an inner annular surface of the external cylinder 4131. Said ribs extend along an axial direction of the external cylinder 4131, and the axial direction of the external cylinder 4131 is arranged parallel to the first direction D1. The spring 4132 is connected to the displacement unit 4133 and a bottom surface in the external cylinder 4131, and the spring 4132 is capable of expanding and compressing along the first direction D1. The displacement unit 4133 is movably mounted in the external cylinder 4131. The displacement unit 4133 has multiple straight grooves and oblique grooves formed on an outer annular surface of the displacement unit 4133. The straight grooves penetrate the displacement unit 4133 along the first direction D1. The oblique grooves are inclined with respect to the first direction D1 but do not completely penetrate the displacement unit 4133. The straight grooves and the oblique grooves are alternately arranged along a circumferential direction of the displacement unit 4133. Each time the displacement unit 4133 is pressed toward the bottom surface of the external cylinder 4131 and pushed out by the spring 4132, the displacement unit 4133 rotates such that the ribs of the external cylinder 4131 switch locations between the straight grooves and the oblique grooves. Since the lengths in the first direction D1 of the straight groove and the oblique groove are different, the displacement unit 4133 is capable of being at two different locations with respect to the housing 1 within the first direction D1. Moreover, each one of the main bodies 411 abuts the corresponding displacement unit 4133, and thus the main body 411 may be located at the elevated position (the main body 411A) and the pushed position (the main body 411B) as shown in FIGS. 14 and 17 via the displacement unit 4133.

The unlocking driving piece 42 is mounted in the accommodating chamber 12. The button sets 41 are mounted through the unlocking driving piece 42 along the first direction D1. The unlocking driving piece 42 is movable with respect to the housing 1 along the second direction D2, thereby selectively engaging with the guiding sleeve 412 of the button set 41. To be more precise, the unlocking driving piece 42 has multiple unlocking rib portions 421 and an unlocking end portion 422. The guiding sleeves 412 are located above the unlocking rib portions 421. As shown in FIG. 14, when all of the guiding sleeves 412 are moved along the first direction D1 until the unlocking combining recesses 4122 are aligned with the unlocking rib portion 421, the unlocking driving piece 42 is movable with respect to the housing 1 along the second direction D2 away from the lock core assembly 2, and all of the unlocking rib portions 421 enter the unlocking combining recesses 4122 of the guiding sleeves 412, such that the unlocking driving piece 42 and the guiding sleeves 412 engage with each other.

The unlocking end portion 422 is mounted at a side of the unlocking driving piece 42 oriented toward the lock core assembly 2, and the unlocking end portion 422 abuts the core casing 20. In this embodiment, the unlocking end portion 422 is shaped as a shank, and an end of the unlocking end portion 422 which is oriented toward the lock core assembly 2 is a sharp end and is selectively disposed in the side recess 213. The unlocking end portion 422 is slidable along the bottom surfaces of the side recess 213.

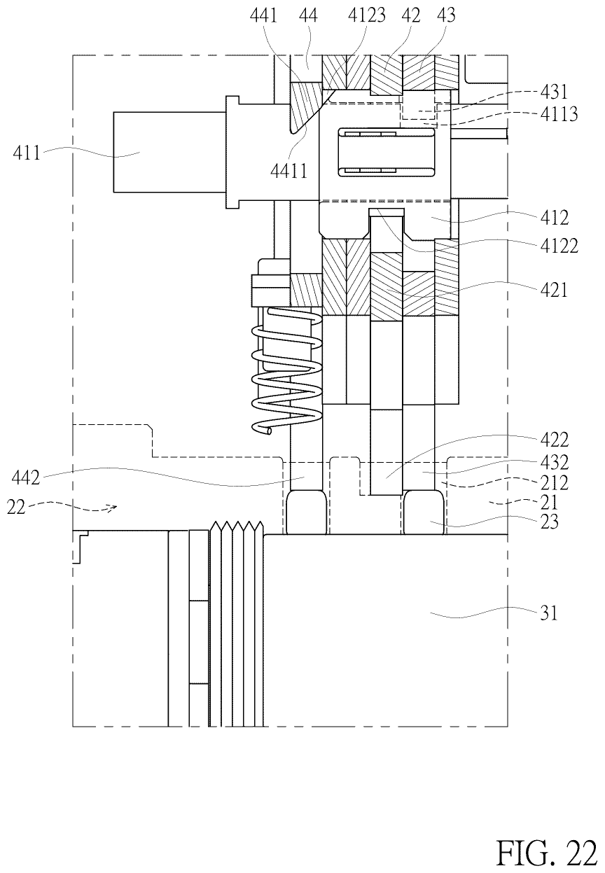

The fixing driving piece 43 is mounted in the accommodating chamber 12. The button sets 41 are mounted through the fixing driving piece 43 along the first direction D1. The fixing driving piece 43 is movable with respect to the housing 1 along the second direction D2, thereby selectively engaging with the main bodies 411. To be more precise, the fixing driving piece 43 has multiple fixing rib portions 431 and a fixing end portion 432. The main bodies 411 of the button sets 41 are disposed below the fixing rib portion 431. As shown in FIG. 22, when the fixing combining recesses 4113 of all of the main bodies 411 are aligned with the fixing rib portions 431 in the first direction D1, the fixing driving piece 43 is movable close to the lock core assembly 2 with respect to the housing 1 along the second direction D2, and all of the fixing rib portions 431 enter the fixing combining recesses 4113 of the main bodies 411, such that the fixing driving piece 43 and main body 411 engage with each other. The main bodies 411 are thus fixed and incapable of moving with respect to the housing 1 along the first direction D1.

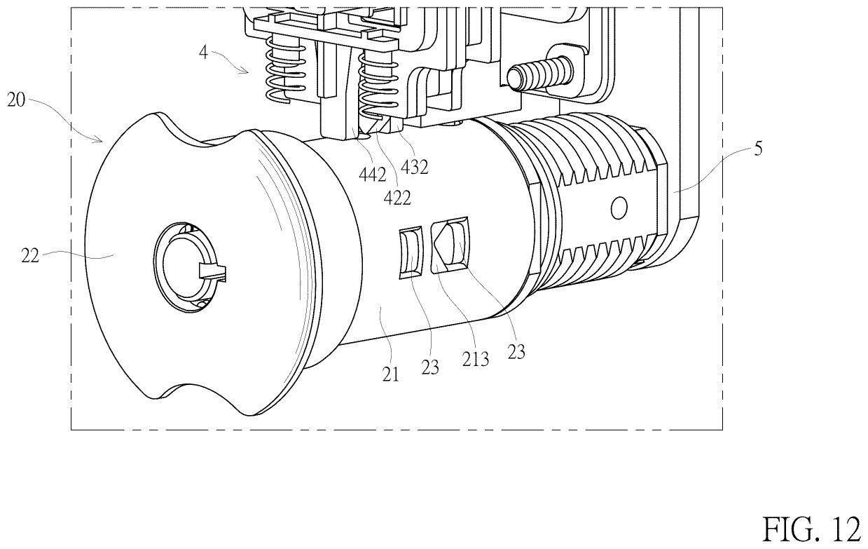

The fixing end portion 432 is mounted at a side of the fixing driving piece 43 oriented toward the lock core assembly 2, and the fixing end portion 432 abuts the core casing 20 and is selectively disposed through the lateral hole 212. Similarly, in this embodiment, the fixing end portion 432 is also shaped as a shank, and an end of the fixing end portion 432 which is oriented toward the lock core assembly 2 abuts the spacing block 23. An elastic unit is mounted at a side of the fixing end portion 432 away from the lock core assembly 2, and the elastic unit presses the fixing driving piece 43 to move to the lock core assembly 2. Therefore, when the linear groove 311 of the inner rotating cylinder 31 is aligned with the lateral holes 212 of the annular wall portion 21, the fixing end portion 432 would push the spacing block 23 to enter the linear groove 311, and meanwhile the fixing end portion 432 is disposed through the lateral hole 212. However, with reference to FIG. 12, when the button-type combination lock in this disclosure is under the unlocked state, the fixing end portion 432 abuts the outer annular surface of the annular wall portion 21.

The resetting driving piece 44 is mounted in the accommodating chamber 12, and the resetting driving piece 44 is sleeved on the button sets 41. The resetting driving piece 44 is movable with respect to the housing 1 along the second direction D2, and thereby pushes the guiding sleeves 412 which are at the second position to move back to the first position with respect to the housing 1 along the first direction D1. The resetting driving piece 44 has multiple oblique pressing portions 441 and a resetting end portion 442. The oblique pressing portions 441 are respectively disposed adjacent to the button sets 41, and each one of the oblique pressing portions 441 and the guiding sleeve 412 of a corresponding one of the button sets 41 are spaced apart from each other along the second direction D2. To be more precise, each one of the oblique pressing portions 441 has an oblique pushing surface 4411 facing towards the corresponding button set 41. The oblique pushing surface 4411 extends along the first direction D1 and inclined away from the corresponding button set 41. When the resetting driving piece 44 pushes the guiding sleeves 412, the oblique pushing surface 4411 of each one of the oblique pressing portions 441 abuts the end of the guiding sleeve 412 of the corresponding button set 41, and said end of the guiding sleeve 412 is oriented toward the operating surface 11. In this embodiment, the oblique pushing surface 4411 abuts the inclined surface 4123 which is connected between the end surface of the guiding sleeve 412 oriented toward the operating surface 11 and the surface of the guiding sleeve 412 facing away from the lock core assembly 2, but it is not limited thereto.

The resetting end portion 442 is mounted at a side of the resetting driving piece 44 oriented toward the lock core assembly 2, and the resetting end portion 442 abuts the core casing 20 and is selectively disposed through the lateral hole 212. Similarly, in this embodiment, the resetting end portion 442 is shaped as a shank unit, and an end of the resetting end portion 442 which is oriented toward the lock core assembly 2 abuts the spacing block 23. A pushing portion 443 is mounted at a side of the resetting driving piece 44 away from the lock core assembly 2, and the pushing portion 443 protrudes from the housing 1 along the second direction D2. When the linear groove 311 of the inner rotating cylinder 31 is aligned with the lateral holes 212 of the annular wall portion 21, the resetting end portion 442 pushes the spacing block 23 to enter the linear groove 311, and the resetting end portion 442 is disposed through the lateral hole 212. In other words, the linear groove 311 provides space for the resetting driving piece 44 to move, and thus the user may press the pushing portion 443 of the resetting driving piece 44 to move the resetting driving piece 44 with respect to the housing 1 along the second direction D2, further pushing the guiding sleeves 412 which are at the second position to move to the first position via the resetting driving piece 44. However, with reference to FIG. 12, when the button-type combination lock is under the unlocked state, the resetting end portion 442 abuts the outer annular surface of the annular wall portion 21.

Multiple spacing pieces 45 are disposed between the unlocking driving piece 42 and the fixing driving piece 43, and between the unlocking driving piece 42 and the resetting driving piece 44, thereby fixing relative positions of the unlocking driving piece 42, the fixing driving piece 43, and the resetting driving piece 44 along the first direction D1, but it is not limited thereto.

With reference to FIGS. 1 to 4 and 6, the latch 5 is mounted through the housing 1 and connected to the core casing 20, and the latch 5 is configured to fix the object to be locked such as doors of a cabinet or a drawer. In this embodiment, the latch 5 is connected to the annular wall portion 21, and thereby the core casing 20 is capable of driving the latch 5 to rotate.

With reference to FIGS. 2, 18, and 20, the reset device 6 is configured to connect with the lock core 30 of the lock core assembly 2. To be more precise, the reset device 6 is capable of connecting with the combining set 302, and pushing the lock pins 351 such that the receiving recesses 3511 are aligned with the lateral crossing channel 332 along the first direction D1, and thus the lock core 30 is rotatable with respect to the core casing 20 to the reset position. In this embodiment, the reset device 6 is a key and may be inserted into the keyhole 222 of the handle portion 22, but it is not limited thereto.

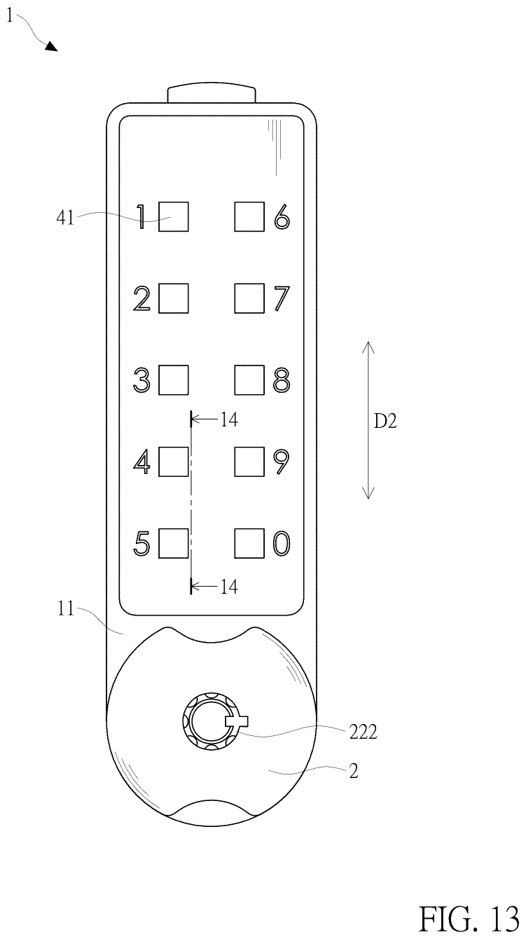

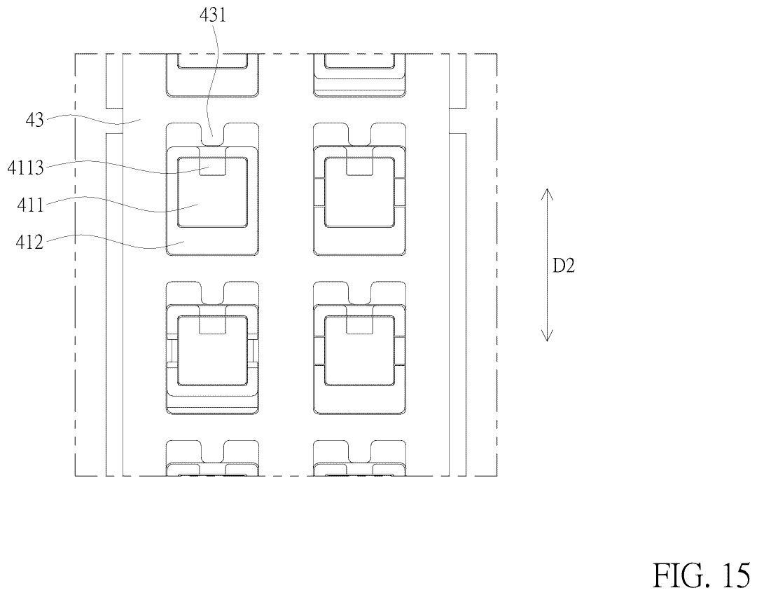

With reference to FIGS. 13 to 15, in this disclosure, when the main body 411A of the button set 41 is at the elevated position and the guiding sleeve 412 is at the first position, the unlocking combining recess 4122 of the guiding sleeve 412 is aligned with the unlocking rib portion 421 of the unlocking driving piece 42 with respect to the housing 1 along the first direction D1. In contrast, when the main body 411B of the button set 41 is at the pushed position and the guiding sleeve 412 is at the second position, the unlocking combining recess 4122 of the guiding sleeve 412 is aligned with the unlocking rib portion 421 of the unlocking driving piece 42 with respect to the housing 1 along the first direction D1. The user may set a password by applying the two abovementioned statuses to the button sets 41.

Rotate the handle portion 22, and then the unlocking end portion 422 of the unlocking driving piece 42 which is disposed in the side recess 213 of the annular wall portion 21 would be pushed by the inclined bottom surfaces of the side recess 213 to an outer diameter of the annular wall portion 21, and thus all of the unlocking rib portions 421 of the unlocking driving piece 42 would enter the unlocking combining recesses 4122 of the guiding sleeves 412 to unlock. Meanwhile, since the guiding sleeves 412 are limited by the unlocking driving piece 42 and are incapable of moving along the first direction D1, the user may press the main bodies 411 to change between the elevated position (the main body 411A) and the pushed position (the main body 411B) to further change/set the password, instead of the prior arts for which the user has to open the locked objects such as cabinet doors or drawers to change/set the password. The button-type combination lock is easy for the user to change the password from the operating surface 11.

With reference to FIGS. 6, 11, and 17, when the button-type combination lock is under the locked state, the unlocking end portion 422 is in the side recess 213, and the fixing end portion 432 abuts the spacing block 23. Since the fixing rib portions 431 do not block the movements of the main bodies 411 along the first direction D1, the user is able to freely press the button sets 41 at the operating surface 11, to further switch each one of the main bodies 411 between the elevated position (the main body 411A) and the pushed position (the main body 411B). As long as not all of the unlocking combining recesses 4122 of the guiding sleeves 412 are simultaneously aligned with the unlocking rib portions 421, the unlocking driving piece 42 would not be able to move along the second direction D2, and thus the core casing 20 would be blocked from rotating by the unlocking end portion 422, and furthermore, the latch 5 is also blocked from rotating.

With reference to FIGS. 12 to 15, when the button-type combination lock in this disclosure is under the unlocked state, the unlocking combining recesses 4122 of all of the guiding sleeves 412 are aligned with the unlocking rib portions 421, providing space for the unlocking driving piece 42 to move. Therefore, when the user rotates the core casing 20 via the handle portion 22, the bottom surfaces of the side recess 213 push the unlocking end portion 422 and further drive the unlocking driving piece 42 to move, and thus the handle portion 22 can be rotated normally and drives the latch 5 to rotate therewhile. Besides, under the unlocked state, the unlocking driving piece 42 engages with the guiding sleeves 412 to block the guiding sleeve 412 from moving along the first direction D1, but the fixing driving piece 43 does not engage with the main bodies 411, such that the user can press the main bodies 411 to move with respect to the guiding sleeves 412, thereby switching the guiding sleeves 412 between the first position and the second position with respect to the main body 411 to set the password.

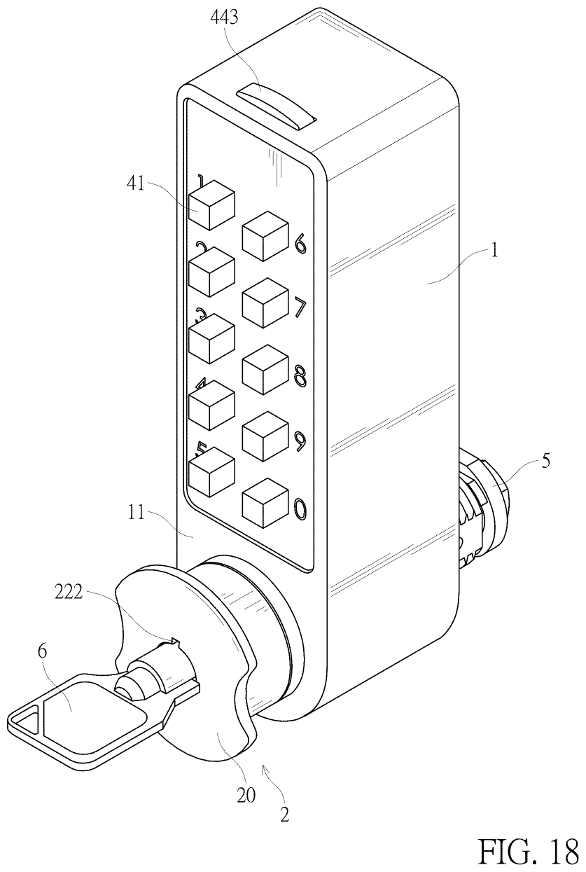

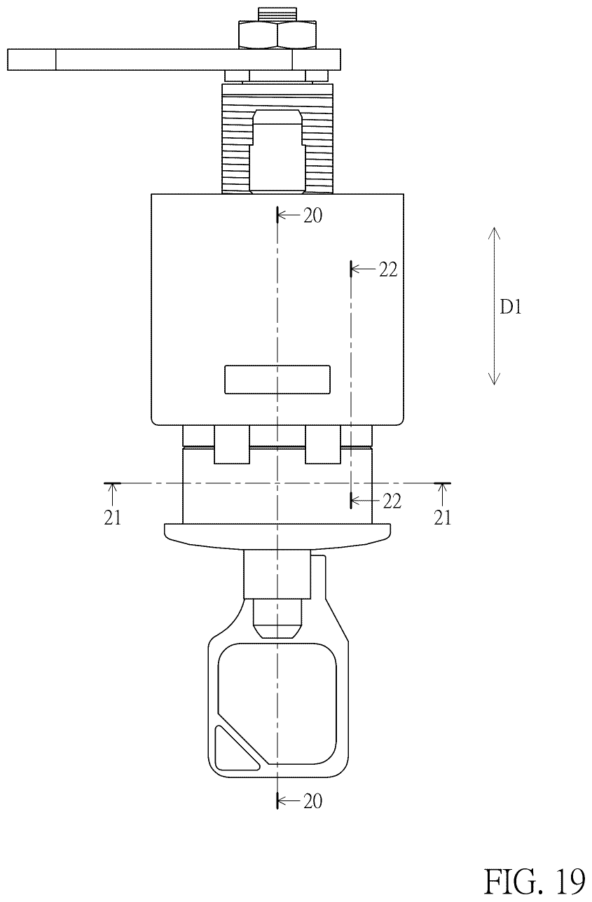

With reference to FIGS. 18 to 22, the button-type combination lock is under the reset state. The user may insert the reset device 6 into the button-type combination lock when it is under the locked state, and the reset device 6 would connect with the lock core 30 through the keyhole 222. The reset device 6 presses the lock pins 351 to align the receiving recesses 3511 and the lateral crossing channel 332 in the first direction D1, and thus the engaging pieces 341 are pressed inward. In addition, meanwhile, the lock pins 351 protrude from the outer rotating cylinder 33 and enter the connecting holes 3221 on the disc portion 322 of the axle 32, but do not penetrate into the holes of the anti-cracking unit 36, thus the lock core 30 being capable of rotating with respect to the core casing 20 to the reset position, i.e., the inner rotating cylinder 31 rotates with respect to the annular wall portion 21 until the linear groove 311 is aligned with the two lateral holes 212, and the two spacing blocks 23 are pressed into the linear groove 311 by the password pad assembly 4.

When the lock core 30 is at the reset position, the linear groove 311 of the inner rotating cylinder 31 is aligned with the lateral holes 212 of the annular wall portion 21, and when the main bodies 411 of all of the button sets 41 are at the elevated position, the fixing combining recesses 4113 of all of the main bodies 411 are aligned with the fixing rib portions 431, providing space for the fixing driving piece 43 to move along the second direction D2, and thus the fixing driving piece 43 is pushed toward the lock core assembly 2 and engages with all of the main bodies 411 to block the main bodies 411 from moving along the first direction D1, and meanwhile, the fixing end portion 432 is disposed through the core casing 20.

Since the core casing 20 does not rotate, the unlocking driving piece 42 is separated from the guiding sleeves 412, and thus the guiding sleeves 412 are movable with respect to the main bodies 411. The user may press the pushing portion 443 of the resetting driving piece 44 therewhile to move the resetting driving piece 44 along the second direction D2. The resetting end portion 442 of the resetting driving piece 44 then enters the core casing 20, such that the resetting driving piece 44 presses the guiding sleeves 412, and thereby each one of the guiding sleeves 412 would be at the first position; the abovementioned is the reset state in this disclosure. Therefore, the guiding sleeves 412 which are at the second position would be pressed to the first position by the resetting driving piece 44, completing the password resetting and restoring the button-type combination lock to a default state as at the time of manufacture.

As mentioned above, the lengths of the lock pins 351 of the lock pin modules 35 may be different from each other, or the locations of the receiving recesses 3511 on the lock pins 351 in the first direction D1 may be different from each other; hence it is required to use the compatible reset device 6 to align the receiving recesses 3511 with the lateral crossing channel 332 along the first direction D1, and for the engaging pieces 341 to be pressed inward. If a malicious person pushes the lock pins 351 in another way, the lock pins 351 may penetrate through the disc portion 322 and enter the anti-cracking unit 36. Due to the anti-cracking unit 36 engaging with the core casing 20, when the malicious person rotates the lock core 30, the core casing 20 would also be driven. However, since the unlocking driving piece 42 is blocked by the guiding sleeves 412, the core casing 20 as well as the lock core 30 cannot be rotated, and thus the button-type combination lock can avoid being cracked by the malicious people.

With the reset device 6, the lock core 30, and the password pad assembly 4, the user can reset the password and restore the button-type combination lock to the default state even if the password is lost or forgotten, thereby addressing the issue about incapability of changing or resetting the forgotten password, unlike the locks in the prior arts which cannot be used any more once the password is forgotten. Furthermore, the button sets 41 and the connecting site of the reset device 6 with the lock core 30 are arranged on the operating surface 11, and the user may easily reset the password without disassembling the cabinet doors or the drawers and restore the button-type combination lock to the default state. Meanwhile, the button-type combination lock has the design of anti-cracking, and thus prevents the malicious people from cracking the button-type combination lock in this disclosure via resetting the password.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A button-type combination lock, which has a reset state, comprising:
a housing having a first direction and a second direction which are nonparallel to each other, a surface of the housing oriented in the first direction being an operating surface; the housing having:
an accommodating chamber formed in the housing; and
a core recess recessed from the operating surface of the housing, and the core recess and the accommodating chamber spatially communicating with each other;
a lock core assembly mounted in the core recess and having:
a core casing mounted in the core recess and protruding from the operating surface; and
a lock core mounted in the core casing and rotatable to a reset position with respect to the core casing;
a password pad assembly mounted in the accommodating chamber and having:
multiple button sets mounted in the accommodating chamber, and each one of the button sets including:
a main body disposed through and protruding from the operating surface, and the main body movable along the first direction; and
a guiding sleeve sleeved on the main body and movable with respect to the main body along the first direction, and the guiding sleeve selectively located at a first position or a second position with respect to the main body;
an unlocking driving piece connected to the core casing, and the button sets mounted through the unlocking driving piece; the unlocking driving piece movable along the second direction, thereby engaging with the guiding sleeves;
a fixing driving piece, and the button sets mounted through the fixing driving piece; the fixing driving piece movable along the second direction, thereby engaging with the main bodies; and
a resetting driving piece sleeved on the button sets and movable along the second direction, thereby one or more of the guiding sleeves located at the second position being pushed to the first position; and
a latch mounted through the housing and connected to the core casing;
when the button-type combination lock is under the reset state, the lock core is at the reset position, the fixing driving piece engages with the main bodies, the resetting driving piece pushes the guiding sleeves, and thereby each one of the guiding sleeves is located at the first position.

2. The button-type combination lock as claimed in claim 1, wherein:
the main body of each one of the button sets further comprises:
a first limit recess and a second limit recess recessed from an external surface of the main body, and the first limit recess and the second limit recess arranged spaced apart from each other along the first direction; and
the guiding sleeve of each one of the button sets further comprises:
a positioning rib selectively engaging with one of the first limit recess and the second limit recess;
when the guiding sleeve is located at the first position, the positioning rib engages with the first limit recess; when the guiding sleeve is located at the second position, the positioning rib engages with the second limit recess.

3. The button-type combination lock as claimed in claim 1, wherein:
the guiding sleeve of each one of the button sets further comprises an unlocking combining recess recessed from a surface of the guiding sleeve, and said surface of the guiding sleeve faces towards the lock core assembly; and
the unlocking driving piece comprises multiple unlocking rib portions;
wherein the button-type combination lock further has an unlocked state, and when the button-type combination lock is under the unlocked state, the guiding sleeves are moved along the first direction until the unlocking combining recesses are aligned with the unlocking rib portions, and thereby the unlocking driving piece is movable along the second direction, such that the unlocking rib portions are respectively disposed in the unlocking combining recesses of the guiding sleeves.

4. The button-type combination lock as claimed in claim 2, wherein:
the guiding sleeve of each one of the button sets further comprises an unlocking combining recess recessed from a surface of the guiding sleeve, and said surface of the guiding sleeve faces toward the lock core assembly; and
the unlocking driving piece comprises multiple unlocking rib portions;
wherein the button-type combination lock further has an unlocked state, and when the button-type combination lock is under the unlocked state, the guiding sleeves are moved along the first direction until the unlocking combining recesses are aligned with the unlocking rib portions, and thereby the unlocking driving piece is movable along the second direction, such that the unlocking rib portions are respectively disposed in the unlocking combining recesses of the guiding sleeves.

5. The button-type combination lock as claimed in claim 3, wherein the button-type combination lock further has a locked state, and when the button-type combination lock is under the locked state, at least one of the guiding sleeves is moved along the first direction such that the unlocking combining recess is not aligned with the unlocking rib portions.

6. The button-type combination lock as claimed in claim 4, wherein the button-type combination lock further has a locked state, and when the button-type combination lock is under the locked state, at least one of the guiding sleeves is moved along the first direction such that the unlocking combining recess is not aligned with the unlocking rib portions.

7. The button-type combination lock as claimed in claim 1, wherein:
the main body of each one of the button sets further comprises a fixing combining recess recessed from a surface of the main body, and said surface of the main body faces away from the lock core assembly; and
the fixing driving piece comprises multiple fixing rib portions, and when the fixing driving piece is engaged with the main bodies, the fixing rib portions are respectively disposed in the fixing combining recesses of the main bodies.

8. The button-type combination lock as claimed in claim 6, wherein:
the main body of each one of the button sets further comprises a fixing combining recess recessed from a surface of the main body, and said surface of the main body faces away from the lock core assembly; and
the fixing driving piece comprises multiple fixing rib portions, and when the fixing driving piece is engaged with the main bodies, the fixing rib portions are respectively disposed in the fixing combining recesses of the main bodies.

9. The button-type combination lock as claimed in claim 1, wherein the resetting driving piece further comprises:
multiple oblique pressing portions mounted adjacent to the button sets, and each one of the oblique pressing portions disposed spaced apart from the guiding sleeve of a corresponding one of the button sets along the second direction; each one of the oblique pressing portion comprising:
an oblique pushing surface extending along the first direction and inclined along a direction away from the corresponding button set;
when the resetting driving piece pushes the guiding sleeves, the oblique pushing surface of each one of the oblique pressing portions presses an end of the corresponding guiding sleeve, and said end of the guiding sleeve is oriented toward the operating surface.

10. The button-type combination lock as claimed in claim 8, wherein the resetting driving piece further comprises:
multiple oblique pressing portions mounted adjacent to the button sets, and each one of the oblique pressing portions disposed spaced apart from the guiding sleeve of a corresponding one of the button sets along the second direction; each one of the oblique pressing portion comprising:
an oblique pushing surface extending along the first direction and inclined along a direction away from the corresponding button set;
when the resetting driving piece pushes the guiding sleeves, the oblique pushing surface of each one of the oblique pressing portions presses an end of the corresponding guiding sleeve, and said end of the guiding sleeve is oriented toward the operating surface.

11. The button-type combination lock as claimed in claim 1, wherein:
the unlocking driving piece comprises an unlocking end portion, the fixing driving piece comprises a fixing end portion, and the resetting driving piece comprises a resetting end portion; and
the core casing comprises:
an annular wall portion surrounding and forming an inner mounting recess, and the annular wall portion disposed in the core recess and rotatable with respect to the housing, and the latch connected to the annular wall portion; the annular wall portion further comprising:
two lateral holes formed through the annular wall portion along a radial direction of the annular wall portion, the two lateral holes and the inner mounting recess spatially communicating with each other; the fixing end portion selectively disposed through one of the two lateral holes, and the resetting end portion selectively disposed through another one of the two lateral holes; and
a side recess recessed from an outer annular surface of the annular wall portion, and the unlocking end portion selectively disposed in the side recess;
a handle portion fixed on and connected to the annular wall portion and protruding from the operating surface; the handle portion comprising:
an outer mounting recess formed through the handle portion, and the outer mounting recess and the inner mounting recess spatially communicating with each other; and
two spacing blocks movably mounted in the two lateral holes respectively, and the fixing end portion and the resetting end portion abutting the two spacing blocks respectively;
when the button-type combination lock is under the reset state, the resetting end portion and the fixing end portion are disposed through the two lateral holes respectively, and the unlocking end portion is disposed in the side recess.

12. The button-type combination lock as claimed in claim 10, wherein:
the unlocking driving piece comprises an unlocking end portion, the fixing driving piece comprises a fixing end portion, and the resetting driving piece comprises a resetting end portion; and
the core casing comprises:
an annular wall portion surrounding and forming an inner mounting recess, and the annular wall portion disposed in the core recess and rotatable with respect to the housing, and the latch connected to the annular wall portion; the annular wall portion further comprising:
two lateral holes formed through the annular wall portion along a radial direction of the annular wall portion, the two lateral holes and the inner mounting recess spatially communicating with each other; the fixing end portion selectively disposed through one of the two lateral holes, and the resetting end portion selectively disposed through another one of the two lateral holes; and
a side recess recessed from an outer annular surface of the annular wall portion, and the unlocking end portion selectively disposed in the side recess;
a handle portion fixed on and connected to the annular wall portion and protruding from the operating surface; the handle portion comprising:
an outer mounting recess formed through the handle portion, and the outer mounting recess and the inner mounting recess spatially communicating with each other; and
two spacing blocks movably mounted in the two lateral holes respectively, and the fixing end portion and the resetting end portion abutting the two spacing blocks respectively;
when the button-type combination lock is under the reset state, the resetting end portion and the fixing end portion are disposed through the two lateral holes respectively, and the unlocking end portion is disposed in the side recess.

13. The button-type combination lock as claimed in claim 11, wherein the lock core comprises:
a driven set mounted in the inner mounting recess and having:
an inner rotating cylinder located in the inner mounting recess and rotatable with respect to the inner mounting recess, and a linear groove recessed from an outer annular surface of the inner rotating cylinder, and the linear groove extending along an axial direction of the inner rotating cylinder; and
an axle fixed and mounted through the inner rotating cylinder, and extending into the outer mounting recess; and
a combining set mounted in the outer mounting recess and connected to the axle, and a reset device capable of connecting with the combining set;
when the lock core is at the reset position, the reset device connects with the lock core, the linear groove spatially communicates with the two lateral holes, and the two spacing blocks are in the linear groove.

14. The button-type combination lock as claimed in claim 12, wherein the lock core comprises:
a driven set mounted in the inner mounting recess and having:
an inner rotating cylinder located in the inner mounting recess and rotatable with respect to the inner mounting recess, and a linear groove recessed from an outer annular surface of the inner rotating cylinder, and the linear groove extending along an axial direction of the inner rotating cylinder; and
an axle fixed and mounted through the inner rotating cylinder, and extending into the outer mounting recess; and
a combining set mounted in the outer mounting recess and connected to the axle, and a reset device capable of connecting with the combining set;
when the lock core is at the reset position, the reset device connects with the lock core, the linear groove spatially communicates with the two lateral holes, and the two spacing blocks are in the linear groove.

15. The button-type combination lock as claimed in claim 13, wherein the combining set comprises:
an outer rotating cylinder disposed in the outer mounting recess and rotatable with respect to the handle portion, and the outer rotating cylinder connected to the axle; the outer rotating cylinder comprising:
multiple pin channels formed through the outer rotating cylinder along an axial direction of the outer rotating cylinder, and the pin channels spaced apart from each other and arranged along a circumferential direction of the outer rotating cylinder; and
a lateral crossing channel formed through the outer rotating cylinder along a radial direction of the outer rotating cylinder, and the lateral crossing channel spatially communicating with at least one of the pin channels;
a linking unit movably disposed in the lateral crossing channel and selectively protruding from an outer annular surface of the outer rotating cylinder, and thereby the linking unit engaging into a driven recess which is formed on an inner annular surface of the outer mounting recess; and
multiple lock pin modules mounted in the pin channels respectively, and each one of the lock pin modules comprising:
a lock pin disposed in the pin channel and movable with respect to the outer rotating cylinder, and the lock pin having a receiving recess recessed from an outer annular surface of the lock pin;
when the lock core is under the reset position, the receiving recess is aligned with the lateral crossing channel, and the linking unit engages into the receiving recess.

16. The button-type combination lock as claimed in claim 14, wherein the combining set comprises:
an outer rotating cylinder disposed in the outer mounting recess and rotatable with respect to the handle portion, and the outer rotating cylinder connected to the axle;
the outer rotating cylinder comprising:
multiple pin channels formed through the outer rotating cylinder along an axial direction of the outer rotating cylinder, and the pin channels spaced apart from each other and arranged along a circumferential direction of the outer rotating cylinder; and
a lateral crossing channel formed through the outer rotating cylinder along a radial direction of the outer rotating cylinder, and the lateral crossing channel spatially communicating with at least one of the pin channels;
a linking unit movably disposed in the lateral crossing channel and selectively protruding from an outer annular surface of the outer rotating cylinder, and thereby the linking unit engaging into a driven recess which is formed on an inner annular surface of the outer mounting recess; and
multiple lock pin modules mounted in the pin channels respectively, and each one of the lock pin modules comprising:
a lock pin disposed in the pin channel and movable with respect to the outer rotating cylinder, and the lock pin having a receiving recess recessed from an outer annular surface of the lock pin;
when the lock core is under the reset position, the receiving recess is aligned with the lateral crossing channel, and the linking unit engages into the receiving recess.

17. The button-type combination lock as claimed in claim 15, wherein the combining set further comprises:
an anti-cracking unit mounted at an end of the outer rotating cylinder and engaged with the core casing, and the anti-cracking unit forming multiple holes; the holes aligned with the pin channels, and the lock pin of each one of the lock pin modules selectively disposed through a corresponding one of the holes.

18. The button-type combination lock as claimed in claim 16, wherein the combining set further comprises:
an anti-cracking unit mounted at an end of the outer rotating cylinder and engaged with the core casing, and the anti-cracking unit forming multiple holes; the holes aligned with the pin channels, and the lock pin of each one of the lock pin modules selectively disposed through a corresponding one of the holes.

19. The button-type combination lock as claimed in claim 1, wherein each one of the button sets further comprises:
a pressing set fixed and mounted in the accommodating chamber and connected to the main body, and the pressing set abutting the main body, such that the main body is selectively located at an elevated position or a pushed position with respect to the accommodating chamber along the first direction.

20. The button-type combination lock as claimed in claim 18, wherein each one of the button sets further comprises:
a pressing set fixed and mounted in the accommodating chamber and connected to the main body, and the pressing set abutting the main body, such that the main body is selectively located at an elevated position or a pushed position with respect to the accommodating chamber along the first direction.
